(19) United States
(12) Patent Application Publication
(10) Pub. No.: US 2018/0189955 A1
(43) Pub. Date: Jul. 5, 2018

(54) AUGUMENTED REALITY (AR) METHOD AND SYSTEM ENHANCED THROUGH EFFICIENT EDGE DETECTION OF IMAGE OBJECTS

(71) Applicant: Eyal Moshe, Tempe, AZ (US)

(72) Inventor: Eyal Moshe, Tempe, AZ (US)

(21) Appl. No.: 15/860,649

(22) Filed: Jan. 2, 2018

Related U.S. Application Data
(60) Provisional application No. 62/441,549, filed on Jan. 2, 2017.

(51) Int. Cl. G06T 7/13; G06T 7/194; G06T 7/90; G06K 9/62

(52) U.S. Cl. CPC G06T 7/13; G06T 7/194; G06T 2207/10024; G06K 9/6256; G06T 2210/12; G06T 7/90

(57) ABSTRACT

A method of an Augmented Reality (AR) system includes detecting edges of an object of an image of a sequence through a scanning algorithm implemented on a data processing device of the AR system, and reducing overall time of the detection of the edges of the object in accordance with: in the first run of scanning the image, determining xH, xL and y for the object in a grayscale representation of the image, forming a virtual box around the determined xH, xL and y for the object, and scanning for the object solely within the formed virtual box in a subsequent run of the scanning of the image. Further, the method includes enabling separation of a background from the object in the image based on the scanning algorithm implementing the detection of the edges of the object.

### CLAIM OF PRIORITY

This application is a conversion application of U.S. Provisional Application No. 62/441,549 titled AUGMENTED REALITY METHOD AND SYSTEM USING REAL-TIME BODY RECOGNITION AND EDGE DETECTION filed on Jan. 2, 2017. The contents of the aforementioned application are incorporated by reference in entirety thereof.

### FIELD OF TECHNOLOGY

This disclosure relates generally to Augmented Reality (AR) systems and, more particularly, to an AR method and a system enhanced through efficient edge detection of image objects.

### BACKGROUND

Augmented Reality (AR) systems may require modification of backgrounds of image objects in original frames thereof. The aforementioned modification may require, as a precondition, edge detection of the image objects within the original frames thereof. However, edge detection may be an inefficient and tedious process with a lot of iterations involving scanning for said image objects.

### SUMMARY

Disclosed are a method, a device and/or a system of Augmented Reality (AR) enhanced through efficient edge detection of image objects.

In one aspect, a method of an AR system includes detecting edges of an object of an image of a sequence through a scanning algorithm implemented on a data processing device of the AR system. The object of the image is identified through an AR algorithm interfaced with the scanning algorithm implemented on the data processing device.

The method also includes reducing overall time of the detection of the edges of the object through the scanning algorithm in accordance with: in the first run of scanning the image, determining xH, xL and y for the object in a grayscale representation of the image, xH representing a highest x-axis value of a white pixel corresponding to the object, xL representing a highest y-axis value of a white pixel corresponding to the object and y representing a smallest y-axis value of a white pixel corresponding to the object in a reference x-y coordinate system of the image such that a range of x-y coordinates thereof delimited by xH, xL and y is largest, forming a virtual box around the determined xH, xL and y for the object after factoring in a threshold value corresponding to motion of the object across the sequence, and scanning for the object solely within the formed virtual box to account for a change in at least one of xH, xL and y thereof in a subsequent run of the scanning of the image.

Further, the method includes enabling separation of a background from the object in the image based on the scanning algorithm implementing the detection of the edges of the object.

In another aspect, a data processing device of an AR system includes a memory, and a processor communicatively coupled to the memory. The processor is configured to execute instructions to detect edges of an object of an image of a sequence through a scanning algorithm implemented on the processor of the AR system. The object of the image is identified through an AR algorithm interfaced with the scanning algorithm implemented on the processor.

The processor is also configured to execute instructions to reduce overall time of the detection of the edges of the object through the scanning algorithm in accordance with: in the first run of scanning the image, determining xH, xL and y for the object in a grayscale representation of the image, xH representing a highest x-axis value of a white pixel corresponding to the object, xL representing a highest y-axis value of a white pixel corresponding to the object and y representing a smallest y-axis value of a white pixel corresponding to the object in a reference x-y coordinate system of the image such that a range of x-y coordinates thereof delimited by xH, xL and y is largest, forming a virtual box around the determined xH, xL and y for the object after factoring in a threshold value corresponding to motion of the object across the sequence, and scanning for the object solely within the formed virtual box to account for a change in at least one of xH, xL and y thereof in a subsequent run of the scanning of the image.

Further, the processor is configured to execute instructions to enable separation of a background from the object in the image based on the scanning algorithm implementing the detection of the edges of the object.

In yet another aspect, an AR system includes an image sensor and/or a data source to capture an object in an image of a sequence, and a data processing device. The data processing device is configured to detect edges of the object in the image of the sequence through a scanning algorithm implemented on the data processing device. The object of the image is identified through an AR algorithm interfaced with the scanning algorithm implemented on the data processing device.

The data processing device is also configured to reduce overall time of the detection of the edges of the object through the scanning algorithm in accordance with: in the first run of scanning the image, determining xH, xL and y for the object in a grayscale representation of the image, xH representing a highest x-axis value of a white pixel corresponding to the object, xL representing a highest y-axis value of a white pixel corresponding to the object and y representing a smallest y-axis value of a white pixel corresponding to the object in a reference x-y coordinate system of the image such that a range of x-y coordinates thereof delimited by xH, xL and y is largest, forming a virtual box around the determined xH, xL and y for the object after factoring in a threshold value corresponding to motion of the object across the sequence, and scanning for the object solely within the formed virtual box to account for a change in at least one of xH, xL and y thereof in a subsequent run of the scanning of the image.

Further, the data processing device is configured to enable separation of a background from the object in the image based on the scanning algorithm implementing the detection of the edges of the object.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of conventional edge detection applied to an example 8-bit grayscale image.

FIG. 2 is a schematic view of Canny Edge detection applied to another example 8-bit grayscale image.

FIG. 3 is a schematic view of a scanned image using a pixel based detection method.

FIG. 4 is a schematic view of a human object of an original image placed in a new background using the pixel based detection method.

FIG. 5 is a schematic view of an image object on a screen of a display device.

FIG. 6 is a schematic view of edge detection of the image object of FIG. 5, according to one or more embodiments.

FIG. 7 is a schematic view of an example implementation of a scanning algorithm in the display device of FIG. 5.

FIG. 8 is a schematic view of motion of pixels across two frames of a video sequence.

FIG. 9 is a schematic view of an Augmented Reality (AR) system in which the scanning algorithm of FIG. 7 is implemented, according to one or more embodiments.

FIG. 10 is a schematic view of unwanted background area around an object of an image to be removed through the edge detection through the scanning algorithm of FIG. 7.

FIG. 11 is a process flow diagram detailing the operations involved in a method of the AR system of FIG. 9, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of Augmented Reality (AR) enhanced through efficient edge detection of image objects. Although the present embodiments have been described with reference to specific example embodiments, it will be evident that various modifications and changes may be made to these embodiments without departing from the broader spirit and scope of the various embodiments.

“Edge detection,” as discussed herein, may refer to one or more image processing techniques to determine boundaries of objects (e.g., human bodies) within images/video frames. Said one or more image processing techniques may involve detecting discontinuities in pixel brightness across an image/video frame.

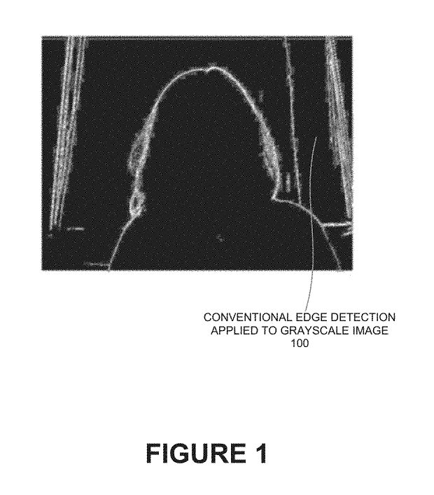

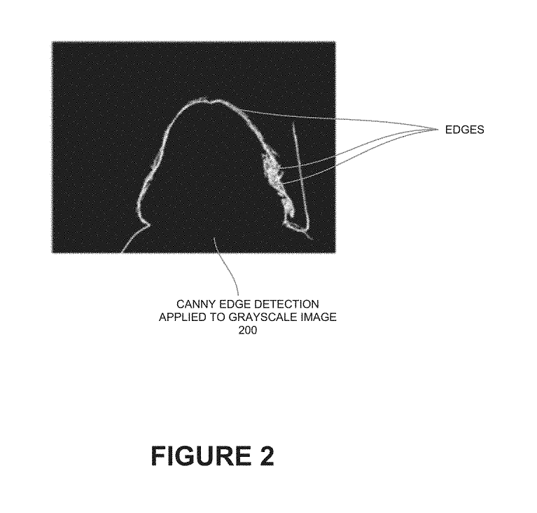

FIG. 1 shows conventional edge detection applied to an example 8-bit grayscale image 100. In grayscale image 100, the value of pixels may represent intensity levels thereof, which ranges from a value of 0 to a value of 255. Here, black colored portions may represent pixel values closer to 0 and white colored portions may represent pixel values closer to 255. FIG. 2 shows Canny Edge detection applied to another example 8-bit grayscale image 200. FIG. 2 clearly shows edges of an object (e.g., a human face) in grayscale image 200 with a largest perimeter therein.

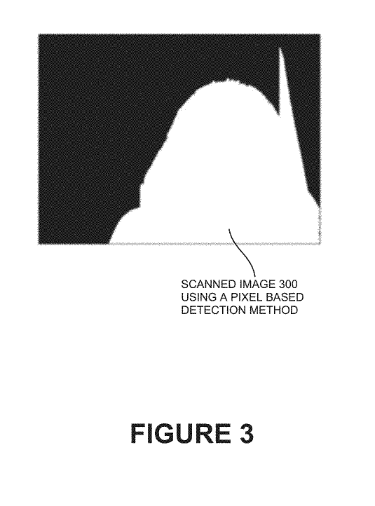

FIG. 3 shows a scanned image 300 using a pixel based detection method. The pixel based detection method may scan an original image (not shown) to search for white colored portions (white pixels), starting from a bottom of the original image and going up to a top thereof column-wise. If scanning proceeds from black colored portions (black pixels) to white colored portions (white pixels), said scanning may interpret all black colored portions firstly as white colored portions. Specifically, if the original image includes a human object, both a face portion and a body portion may be included in scanned image 300 as white colored portions, as shown in FIG. 3.

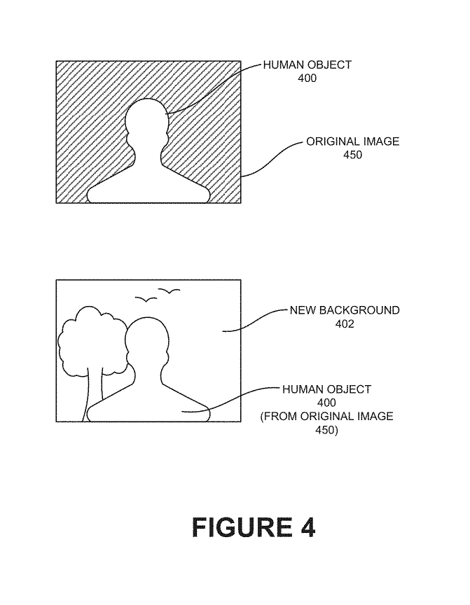

FIG. 4 shows a human object 400 of the original image (e.g., original image 450) placed in a new background 402 using the pixel based detection method. Exemplary embodiments discussed herein utilize similar techniques of pixel based detection to perform chroma keying (known to one skilled in the art), eliminating certain color hues and/or eliminating black colored portions around a human object (e.g., human object 400).

Exemplary embodiments discussed herein may also include edge detection based on scanning the original image (e.g., original image 450). For example, the original image may be scanned from a left boundary to a right boundary thereof. When a white colored portion (white pixel) of the original image is reached for the first time during scanning, the process of filling in pixels may be initiated. The correct black pixels between two white pixels may be filled as white pixels. Alternately, said correct black pixels (and the white pixels in the original image) may be replaced instead with pixels from an original array representing the original image/frame.

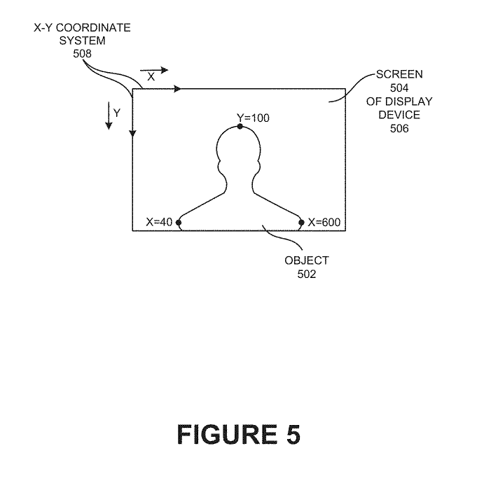

During scanning, widths of edges of objects within the original image may be detected. In an example embodiment, if an edge is 2 pixels thick, a set of two pairs of white pixels may be scanned for when filling in the pixels to render the scanning more effective. FIG. 5 shows an object 502 on a screen 504 of a display device 506. In accordance with the object identification disclosed herein, a two-dimensional (e.g., x-y) coordinate system may be implemented; FIG. 5 shows x-y coordinate system 508, according to one or more embodiments.

In accordance with object 502 identified on screen 504 (or, from an original image), a box may be created using the largest range of x and y coordinates thereof. In an example embodiment, if y=100 is the first spot that a white pixel is detected on the first run, then during the next time of detection of object 502, the scan may be started at, say, y=70, instead of at y=0. Likewise, if object 502 is first spotted at x=40 and last at x=600, then during the next time, object 502 may only be looked for, say, between x=10 and x=630 (here, it may be assumed that reasonable motion for object 502 between frames is 30 pixels; a moving object 502 is assumed here).

The abovementioned x-y coordinates may form a “box” after taking into account reasonable movement of object 502. If object 502 is not spotted in this “box,” object 502 may be searched for in the rest of screen 504 (original image/frame) and the detection process may be restarted. If the smallest y-value, the smallest x-value and/or the largest x-value changes, the method may reassign the values based on the new one or more extreme(s) and adjust the “box” accordingly. This may cover all small movements well, but may adjust slower for more rapid movements.

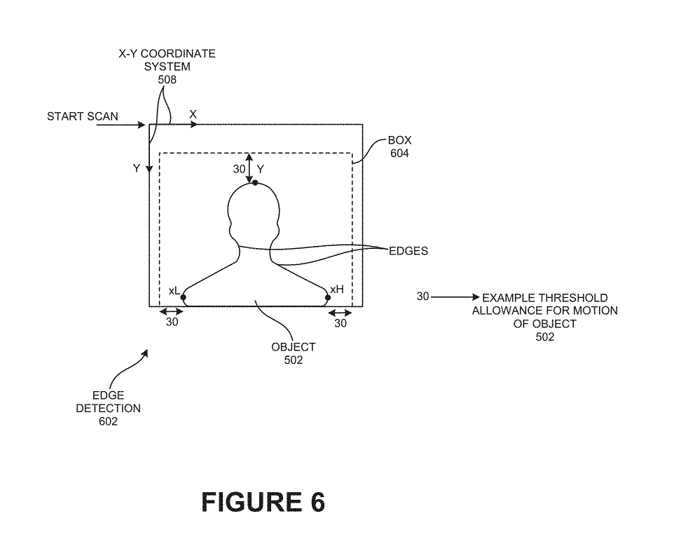

FIG. 6 shows edge detection 602 of object 502 of FIG. 5, according to one or more embodiments. In the first run of scanning from left to right, xH, xL and y may be found for object 502. xH may represent the highest x-value of object 502 during detection, xL may represent the lowest x-value of object 502 during detection and y may represent the smallest y-value of object 502 during detection. The aforementioned three x-y values, after factoring the threshold allowance (e.g., 30) for motion thereinto, may form the “box” (e.g., box 604) discussed above.

If a white pixel is reached for the first time during scanning, the process of filing in pixels with original pixels (if possible) may be initiated. To replace the black pixels inside object 502 (e.g., human object), the method may involve proceeding in pairs: If there is a white pixel at y=100 when x=600, the process of filling in black pixels with original pixels (and/or white if that is not possible) in a corresponding row may not be started until another white pixel is found. As seen above, box 604 may be formed around xH+30, xL−30 and y−30 (30 refers to the threshold allowance for motion discussed above; some other pixel number may also be chosen to account for reasonable movement of a person (e.g., object 502) between images/frames).

In one or more embodiments, box 604 may be scanned for on each subsequent run-through. If movement of object 502 is detected by way of detection of a change in xH, xL and/or y, the values of xH, xL and/or y (and box 604) may be updated to reflect a new position of object 502. In one or more embodiments, if object 502 is not found in box 604, object 502 may once again be scanned for across an entirety of screen 504 (or, the original image/frame).

It is to be noted that a black and white image with edges detected may be represented as BW2(i, j), an m×n matrix. In one example embodiment, m=480 and n=640, which implies that i ranges from 1 to 480 and j from 1 to 640. In other words, there may be 480 rows and 640 columns; the highest possible x may be 640 and the highest possible y may be 480. It is obvious to note that the abovementioned processes may be more efficient when a user (e.g., corresponding to object 502) is centered as best as possible within box 604. In one or more embodiments, exceptions may be implemented to account for both a head of the user and an image thereof being half in-half out of the frame.

In one or more alternate embodiments, scanning of the original image (screen 504) may be performed sideways; in the second run, scanning may proceed down-up. All variations in direction of scanning are within the scope of the exemplary embodiments discussed herein.

An example fixing of undesired horizontal lines in a scanned image (e.g., scanned image 300) may involve checking whether there is a white pixel one row above and one row below a black pixel. If yes, the black pixel in question may be changed to a white pixel. A second checking may involve determining whether there is a white pixel two rows above and two rows below. This may be to ensure modification of two error pixels to white.

To summarize, edge detection 602 of object 502 of FIG. 5 may involve creating a virtual box 604 to enclose object 502 therewithin. The lowest value of x (xL), a white pixel, minus a threshold value (say, 30; may need to be larger or smaller to represent potential motion of object 502 between images/frames) may represent the leftmost side of box 604 (xL−30). The highest value of x (xH), a white pixel, plus the threshold value (say, 30; may need to be larger or smaller to represent potential motion of object 502 between images/frames) may represent the rightmost side of box 604 (xL+30). The smallest value of y, a white pixel, minus the threshold value (say, 30; may need to be larger or smaller to represent potential motion of object 502 between images/frames) may represent the top side of box 604.

In one example embodiment, the bottom of box 604 be may be represented at a default value of 480 because object 502 may always have a bottom edge thereof at bottom of screen 504. It should be noted that if the threshold value cannot be subtracted or added to xH, xL or y, the highest/lowest values of x or y may be defaulted to. As discussed above, box 604 may be scanned instead of scanning the whole image/frame (screen 504) for object 502 (e.g., a face and/or a body of a human being).

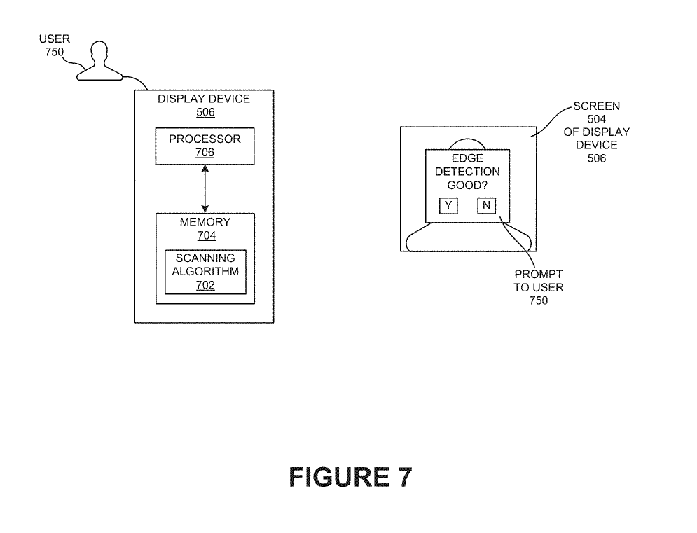

If object 502 is found at a different spot during an iteration, edge values of box 604 may be adjusted such that box 604 is modified. If object 502 is not found within box 604, the detection process may be restarted from a top of the image/frame (screen 504), as discussed above. FIG. 7 shows an example implementation of a scanning algorithm 702 in accordance with the processes discussed above in display device 506 (e.g., a data processing device such as a mobile phone, a computing device and a smart device; other devices are within the scope of the exemplary embodiments discussed herein).

In FIG. 7, scanning algorithm 702 is shown as being part of a memory 704 (e.g., a non-volatile memory and/or a volatile memory) of display device 506 communicatively coupled to a processor 706 (e.g., a Central Processing Unit (CPU), a Graphics Processing Unit (GPU), a microprocessor, a microcontroller); scanning algorithm 702 is configured to be executable through processor 706 to perform the operations discussed above (and herein). In the example implementation, scanning algorithm 702 may enable a user 750 of display device 506 to be prompted with regard to whether edge detection of object 502 by way of box 604 is good. If user 750 finds screen 504 (or, the image/frame therein) undesirable, he/she may enable redetection of object 502 using edges thereof.

If user 750 determines screen 504 to be good, scanning algorithm 702 may transition to a tracking mode of tracking outline(s) of object 502 based on the edges thereof. This may improve speed of the edge detection through scanning algorithm 702.

In one or more embodiments, color-based detection of pixels may supplement the edge detection discussed above to get rid of extraneous information during the edge detection; scanning algorithm 702 may appropriately be implemented.

Now concepts behind determining the white lines/edges of object 502 will be discussed. Image gradients (or, gradient vectors) within an image/frame may provide information related to “lighting invariance,” which is important to account for room for error in different light conditions for which scanning algorithm 702 is executed on images/frames. This means that if pixels are to be made lighter or darker (i.e., increase contrast between light and dark portions of an image, as multiplying by a factor may make bright pixels much brighter and dark pixels only a little brighter), the gradient vector(s) thereof may be increased by a factor; if pixels are to be made invariant, the gradient vector(s) may be divided by magnitude (process of normalizing a vector to a unit length) thereof. The aforementioned technique is used in many computer vision algorithms involving computing gradient vectors for each pixel in an image; detailed discussion associated therewith has been skipped for the sake of convenience and clarity.

A gradient vector of each pixel may measure the change in pixel value (which in an example 8-bit grayscale image range in values from 0 (black)-255 (white)) along the x direction and the y direction around the each pixel:
(right value)−(left value)=rate of change in x-direction
(top value)−(bottom value)=rate of change in y-direction

Gradient vectors may be perpendicular to edges within an image. Pixels of the image with a large negative change may be black, pixels of the image with a large positive change may be white, and pixels with little/no change may be gray. Large gradient values may correspond to strong edges in the image. Here, in one or more embodiments, scanning algorithm 702 may involve computing image derivatives (e.g., based on converting image to a continuous form thereof, taking discrete derivatives based on finite-difference methods) to enable detection of edges based on extrema of the image derivatives that correspond to said edges. Computation of image derivatives is known to one skilled in the art. Detailed discussion associated therewith has been skipped for the sake of convenience and clarity. It should be noted that derivative masks (e.g., based on backward difference) may be employed in computation of image derivatives.

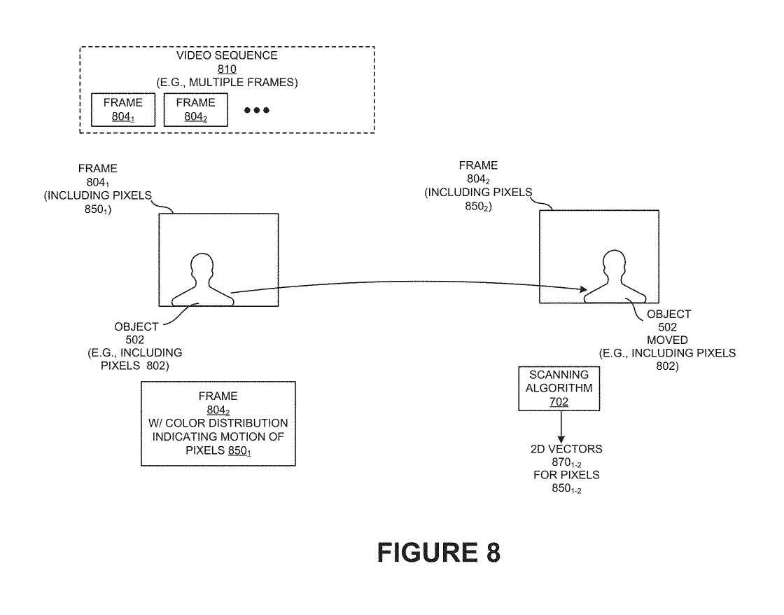

FIG. 8 shows motion of pixels 802 across two frames 804₁₋₂ (can be generalized to multiple frames) of a video sequence 810. In one or more embodiments, to account for said motion of pixels 802, a two-dimensional (2D) vector 870₁₋₂ for each pixel 850₁₋₂ of each frame 804₁₋₂ may be generated through scanning algorithm 702 to enable computation of displacement of pixels 802 across the two frames 804₁₋₂.

In one or more additional or alternate embodiments, motion direction of the each pixel 850₁ may be assigned colors to represent the displacement thereof across the two frames 804₁₋₂. Brightness constancy assumptions and optical flow constraint equations are well known to one skilled in the art for application thereof in determining motion of pixels 802 (and, thereby, change in intensity of pixel values as a function of space and time) across the two frames 804₁₋₂. Detailed discussion associated therewith has been skipped for the sake of convenience and clarity.

It should also be noted that scanning algorithm 702 may be implemented as a Canny Edge Detector (preferred) and/or a Sobel detector. Edge/corner detection methodologies involved in the aforementioned detectors are well known to one skilled in the art. Detailed discussion associated therewith has been skipped for the sake of convenience and clarity.

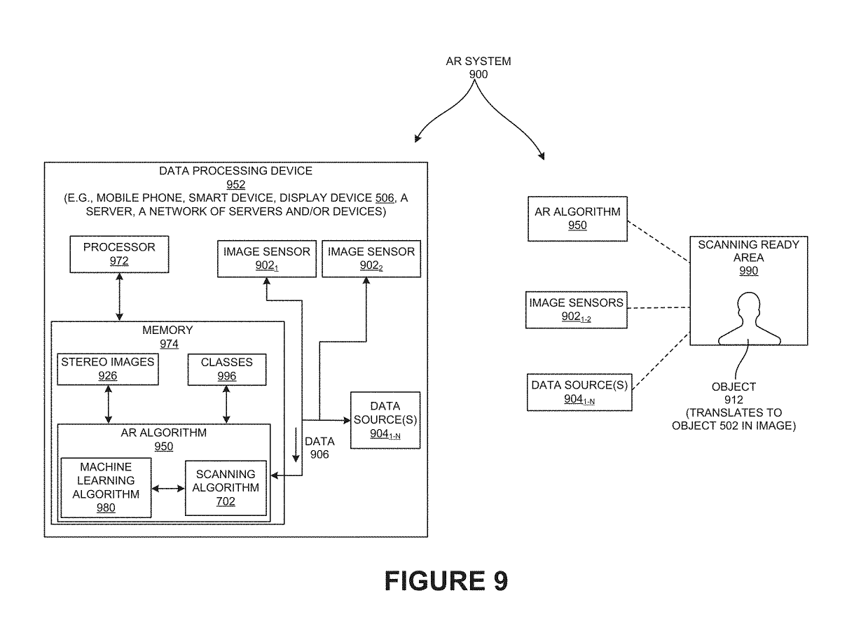

FIG. 9 shows an Augmented Reality (AR) system 900 in which scanning algorithm 702 discussed above is implemented, according to one or more embodiments. “Augmented Reality (AR),” as discussed herein, may refer to a direct or indirect view of a real-world environment where elements of said environment are said to be “augmented” through one or more data (e.g., sensory data such as sound, video and graphics) related thereto. In one or more embodiments, AR system 900 may include two image sensors 902₁₋₂ (e.g., still cameras, video cameras) configured to capture an object 912 (e.g., a human being) from various angles for stereo imaging purposes (e.g., stereo images 926). In one or more embodiments, AR system 900 may include other data source(s) 904_{1-N} to provide additional information related to object 912.

In one or more embodiments, data 906 related to object 912, portions of which may be supplied by each of the two image sensors 902₁₋₂ and data source(s) 904_{1-N}, may be input to an AR algorithm 950 (e.g., including scanning algorithm 702; in general, AR algorithm 950 may be interfaced with scanning algorithm 702) executing on a data processing device 952 (e.g., a mobile phone, a smart device, display device 506, a server, a network of servers and/or data processing device(s)) that enables real-time detection, tracking, analysis and/or understanding of object 912 in front of image sensors 902₁₋₂ and data source(s) 904_{1-N}. In one example implementation, image sensors 902₁₋₂ and/or data source(s) 904_{1-N} may be part of data processing device 952 and interfaced with AR algorithm 950. FIG. 9 shows data processing device 952 as including a processor 972 communicatively coupled to a memory 974; AR algorithm 950 is shown as part of memory 974. It should be easy to see that object 912 translates to object 502 in an image.

In one or more embodiments, AR system 900 may provide an integrated solution of several technologies such as (i) identifying moving parts (e.g., body parts) of object 912/object 502 using machine learning; FIG. 9 shows a machine learning algorithm 980 as part of AR algorithm 950; said machine learning algorithm 980 is interfaced with scanning algorithm 702, (ii) utilizing parts of object 502 detected (e.g., through AR algorithm 950) to create a “scanning ready area” (e.g., scanning ready area 990 of object 912/object 502), (iii) detecting edges of scanning ready area 990 (or, the complete object 502, as discussed above; or, object 502 that is a portion of scanning ready area 990), (iv) color manipulation discussed above, and (v) removal of background information around the “unwanted” areas (e.g., in screen 504, background information around object 502 may be removed in accordance with the edge detection through scanning algorithm 702 discussed above; object 502 may be surrounded by a new background, as shown in FIG. 4).

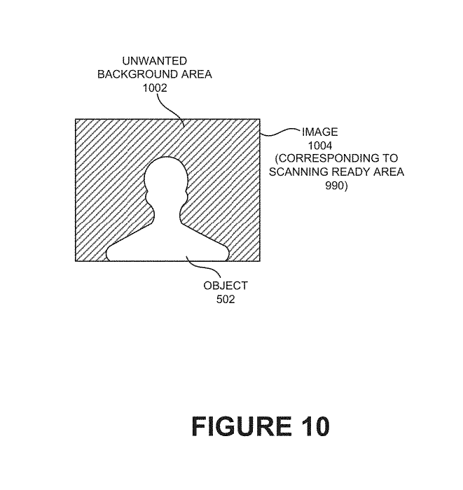

FIG. 10 shows unwanted background area 1002 around object 502 of an image 1004 that is removed through the edge detection through scanning algorithm 702 discussed above, according to one or more embodiments. In one or more embodiments, AR system 900 may involve several building blocks implemented in AR algorithm 950 related to tracking of object 502, object 502 part movement, detection of object 502, edge detection and machine learning, as discussed above. In one or more embodiments, AR algorithm 950 may be implemented in a modularized manner to enable addition of newly developed building blocks thereto.

In one or more embodiments, AR system 900/AR algorithm 950 may provide for an improved green screen experience (chroma keying; background area 1002 around object 502 may be a green screen that is substituted with another background, as shown in FIG. 4; chroma keying is known to one skilled in the art; detailed discussion associated therewith has been skipped for the sake of clarity and convenience), a full-body person recognition system including, but not limited to, full body feature recognition, rotation and three-dimensional (3D) support with depth from disparity controls. In one or more embodiments, AR algorithm 950 may also employ pattern recognition.

In one or more embodiments, AR system 900/AR algorithm 950 may provide for an improved AR technology that utilizes a green screen effect for a variety of applications to identify object 502 (e.g., human body, other objects) when shooting a video and/or taking a photo; AR algorithm 950 may enable the background of object 502 to be replaced and/or substituted with virtual imagery even when object 502 is in motion.

In one or more embodiments, AR system 900/scanning algorithm 702 may be capable of recognizing, in real-time, contour lines of object 502 (e.g., body contour lines of a person) and elements thereof while an image is taken, indoors and/or outdoors. In one or more embodiments, AR algorithm 950/scanning algorithm 702 may represent object 502 and elements thereof by a combination of detection machines. In one or more embodiments, said detection machines may use color-based and/or shape-based features to detect contour lines of object 502, as discussed above. In one or more embodiments, the detection machines may also use camera abilities (e.g., image sensor(s) 902₁₋₂, data source(s) 904_{1-N}) to learn about body heat of object 502 in order to separate detected object 502 and the background thereof.

In one or more embodiments, AR system 900 may use object-class detection through AR algorithm 950/scanning algorithm 702 (scanning algorithm 702 may be considered as part of AR algorithm 950), which implies that AR system 900 may detect the locations and sizes of all objects (e.g., object 502) in an image that belong to a given class element thereof. In one or more embodiments, the defined classes (e.g., classes 996 of FIG. 9) for object 502 may include head, hair, ears, arms, legs, and a body thereof. In one or more embodiments, the detection of object 502 and elements thereof may be accurately recognized in any orientation and/or lighting condition with an emphasis on rapid body movement.

In one or more embodiments, a set of instructions for recognition of object 502 of may execute on data processing device 952. A heat sensor and/or an image processing heat analysis sensor (example data source(s) 904_{1-N}) may be used to recognize heat source as a method and/or technique to improve detection of object 502. In technical terms, use of the heat sensor and/or the image processing heat analysis sensor may allow analysis of the depth from disparity and, basically, separation between the warm object 502 (e.g., a warm human body) from a cold background. This method may allow an easier way to separate object 502 for recognition and to substitute/modify the background thereof.

In one or more embodiments, particular innovative features of AR system 900/AR algorithm 950 may include:

Image Processing:
When analyzing color, the recognition may use combinations of “Support Vector Machines” (SVM).
Multiclass analysis based on SVMs may be explored and compared.
Add constraints and solve with rough edges/contours and/or graphical cuts.

Light and Projection:
Light, structured light and effect thereof on the image may be developed separately and analyzed properly as an algorithm to help clean the image from disruptions.
Basic—This feature may include use of a “projector like” analysis to create known features like contours of object 502 using points and/or lines.
Advanced—This feature may project distinctive points to create image element matches.

Stereo Image:
Basic and/or advanced—Stereo matching algorithm may be implemented in order to match two stereo images.
A stereo system may be used to obtain a wide and detailed range of data.
AR system 900 may determine when a new element is identified and may start tracking of the new element and/or modeling of the tracking of the new element.
Effectively may separate the detected object 502 from the background thereof.
Sections and random dot matching—An algorithm may be used to find a pattern for matches when the dots created are unclear.

In order to match stereo images 926 from image sensors 902₁₋₂, AR system 900 may estimate pose from the depth image to learn about the position and the movement thereof while auto-categorizing, and may run the object-class detection for object 502 and/or elements thereof. In one or more embodiments, AR system 900/AR algorithm 950 may include or consider at least the following:
Real-time gesture recognition and tracking
Wide variety of variation to body types (thin, fat, overweight, short, tall, kid, baby, and/or animal) of object 502 while analyzing orientations, poses etc.
Finding and identifying parts of object 502, using depth and/or pixel analysis
Movement may be analyzed from training videos and/or training (e.g., sports) data to sample from and analyze, and then match data with real body of object 502.
Edges of object 502 may be tempered such that when contours are drawn, lightening and/or smoothening are done in order to achieve a slicker cut of the contours around the edges of object 502.

In one or more embodiments, AR system 900/AR algorithm 950/scanning algorithm 702 may use edge detection techniques that are independent of lighting condition, thereby opening possibilities for different backgrounds. In one or more embodiments, one or more of the edge detection techniques may provide the biggest perimeter object(s) (e.g., object 502) based on edge detection on screen 504, without having to worry about background color. The edge detection may be done for any size of object 502 and/or any posture thereof. In one or more embodiments, the scanning, as discussed above, may be performed left-right across images as part of the edge detection. Exemplary embodiments provide for reduced overall time required to detect extra parts (e.g., object 502) of an original image and putting said object 502 into a new background image.

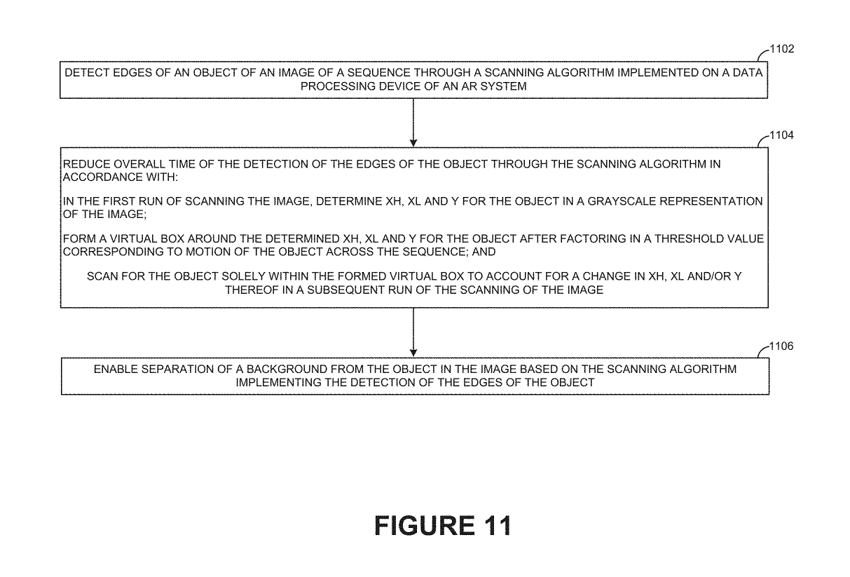

FIG. 11 shows a process flow diagram detailing the operations involved in a method of an AR system (AR system 900), according to one or more embodiments. In one or more embodiments, operation 1102 may involve detecting edges of an object (e.g., object 502) of an image (e.g., frame 804₁) of a sequence (e.g., video sequence 810) through a scanning algorithm (e.g., scanning algorithm 702) implemented on a data processing device (e.g., display device 506, data processing device 952) of the AR system. In one or more embodiments, the object of the image may be identified through an AR algorithm (e.g., AR algorithm 950) interfaced with the scanning algorithm implemented on the data processing device.

In one or more embodiments, operation 1104 may involve reducing overall time of the detection of the edges of the object through the scanning algorithm in accordance with:
in the first run of scanning the image, determining xH, xL and y for the object in a grayscale representation of the image, xH representing a highest x-axis value of a white pixel corresponding to the object, xL representing a highest y-axis value of a white pixel corresponding to the object and y representing a smallest y-axis value of a white pixel corresponding to the object in a reference x-y coordinate system of the image such that a range of x-y coordinates thereof delimited by xH, xL and y is largest,
forming a virtual box (e.g., box 604) around the determined xH, xL and y for the object after factoring in a threshold value corresponding to motion of the object across the sequence, and
scanning for the object solely within the formed virtual box to account for a change in at least one of xH, xL and y thereof in a subsequent run of the scanning of the image.

In one or more embodiments, operation 1106 may then involve enabling separation of a background from the object in the image based on the scanning algorithm implementing the detection of the edges of the object.

Although the present embodiments have been described with reference to a specific example embodiment, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., AR system 900/data processing device 952). Accordingly, the specification and the drawings are to be regarded in an illustrative rather than a restrictive sense.

What is claimed is:

1. A method of an Augmented Reality (AR) system comprising:
detecting edges of an object of an image of a sequence through a scanning algorithm implemented on a data processing device of the AR system, the object of the image identified through an AR algorithm interfaced with the scanning algorithm implemented on the data processing device;
reducing overall time of the detection of the edges of the object through the scanning algorithm in accordance with:
in the first run of scanning the image, determining xH, xL and y for the object in a grayscale representation of the image, xH representing a highest x-axis value of a white pixel corresponding to the object, xL representing a highest y-axis value of a white pixel corresponding to the object and y representing a smallest y-axis value of a white pixel corresponding to the object in a reference x-y coordinate system of the image such that a range of x-y coordinates thereof delimited by xH, xL and y is largest;
forming a virtual box around the determined xH, xL and y for the object after factoring in a threshold value corresponding to motion of the object across the sequence; and
scanning for the object solely within the formed virtual box to account for a change in at least one of xH, xL and y thereof in a subsequent run of the scanning of the image; and
enabling separation of a background from the object in the image based on the scanning algorithm implementing the detection of the edges of the object.

2. The method of claim 1, further comprising:
initiating filling of pixels with original pixels of the image when a white pixel is reached for a first time of scanning the image; and
to replace black pixels inside the object when the white pixel thereof is reached for the first time, filling in the black pixels with corresponding original pixels of the image in a corresponding row thereof only when another white pixel of the object is found.

3. The method of claim 1, further comprising at least one of:
updating the virtual box in accordance with the change in the at least one of xH, xL and y of the object in the subsequent run of the scanning of the image; and
when the object is not found within the updated virtual box in another subsequent run of the scanning of the image, scanning for the object once again across an entirety of the image.

4. The method of claim 1, further comprising:
eliminating undesired horizontal lines in the scanned image based on checking whether there is a white pixel at least one row above and one row below a black pixel; and
changing the black pixel also into a white pixel when there is the white pixel at least one row above and one row below the black pixel.

5. The method of claim 1, further comprising at least one of:
supplementing the edge detection with color-based detection of pixels of the image through the scanning algorithm; and
computing at least one of: gradient vectors for the pixels within the image and image derivatives to further process the pixels of the image and enhance the edge detection of the object therein.

6. The method of claim 1, further comprising:
utilizing parts of the object of the image detected to create a scanning ready area through the AR algorithm; and
in real-time, at least one of: detecting, tracking, analyzing and understanding the object based on data from at least one of: an image sensor and a data source of the AR system.

7. The method of claim 1, further comprising:
identifying moving parts of the object using a machine learning algorithm implemented in the data processing device interfaced with the scanning algorithm.

8. A data processing device of an AR system comprising:
a memory; and
a processor communicatively coupled to the memory, the processor being configured to execute instructions to:
detect edges of an object of an image of a sequence through a scanning algorithm implemented on the processor of the AR system, the object of the image identified through an AR algorithm interfaced with the scanning algorithm implemented on the processor,
reduce overall time of the detection of the edges of the object through the scanning algorithm in accordance with:
in the first run of scanning the image, determining xH, xL and y for the object in a grayscale representation of the image, xH representing a highest x-axis value of a white pixel corresponding to the object, xL representing a highest y-axis value of a white pixel corresponding to the object and y representing a smallest y-axis value of a white pixel corresponding to the object in a reference x-y coordinate system of the image such that a range of x-y coordinates thereof delimited by xH, xL and y is largest,
forming a virtual box around the determined xH, xL and y for the object after factoring in a threshold value corresponding to motion of the object across the sequence, and
scanning for the object solely within the formed virtual box to account for a change in at least one of xH, xL and y thereof in a subsequent run of the scanning of the image, and
enable separation of a background from the object in the image based on the scanning algorithm implementing the detection of the edges of the object.

9. The data processing device of claim 8, wherein the processor is further configured to execute instructions to:
initiate filling of pixels with original pixels of the image when a white pixel is reached for a first time of scanning the image, and
to replace black pixels inside the object when the white pixel thereof is reached for the first time, fill in the black pixels with corresponding original pixels of the image in a corresponding row thereof only when another white pixel of the object is found.

10. The data processing device of claim 8, wherein the processor is further configured to execute instructions to least one of:
update the virtual box in accordance with the change in the at least one of xH, xL and y of the object in the subsequent run of the scanning of the image, and
when the object is not found within the updated virtual box in another subsequent run of the scanning of the image, scan for the object once again across an entirety of the image.

11. The data processing device of claim 8, wherein the processor is further configured to execute instructions to:
eliminate undesired horizontal lines in the scanned image based on checking whether there is a white pixel at least one row above and one row below a black pixel, and
change the black pixel also into a white pixel when there is the white pixel at least one row above and one row below the black pixel.

12. The data processing device of claim 8, wherein the processor is further configured to execute instructions to at least one of:
supplement the edge detection with color-based detection of pixels of the image through the scanning algorithm, and
compute at least one of: gradient vectors for the pixels within the image and image derivatives to further process the pixels of the image and enhance the edge detection of the object therein.

13. The data processing device of claim 8, wherein the processor is further configured to execute instructions to at least one of:
utilize parts of the object of the image detected to create a scanning ready area through the AR algorithm, and
in real-time, at least one of: detect, track, analyze and understand the object based on data from at least one of: an image sensor and a data source of the AR system.

14. The data processing device of claim 8, wherein the processor is further configured to execute instructions to:
identify moving parts of the object using a machine learning algorithm implemented in the data processing device interfaced with the scanning algorithm.

15. An AR system comprising:
at least one of: an image sensor and a data source to capture an object in an image of a sequence; and
a data processing device to:
detect edges of the object in the image of the sequence through a scanning algorithm implemented on the data processing device, the object of the image identified through an AR algorithm interfaced with the scanning algorithm implemented on the data processing device,
reduce overall time of the detection of the edges of the object through the scanning algorithm in accordance with:
in the first run of scanning the image, determining xH, xL and y for the object in a grayscale representation of the image, xH representing a highest x-axis value of a white pixel corresponding to the object, xL representing a highest y-axis value of a white pixel corresponding to the object and y representing a smallest y-axis value of a white pixel corresponding to the object in a reference x-y coordinate system of the image such that a range of x-y coordinates thereof delimited by xH, xL and y is largest,
forming a virtual box around the determined xH, xL and y for the object after factoring in a threshold value corresponding to motion of the object across the sequence, and
scanning for the object solely within the formed virtual box to account for a change in at least one of xH, xL and y thereof in a subsequent run of the scanning of the image, and
enable separation of a background from the object in the image based on the scanning algorithm implementing the detection of the edges of the object.

16. The AR system of claim 15, wherein the data processing device is further configured to:
initiate filling of pixels with original pixels of the image when a white pixel is reached for a first time of scanning the image, and
to replace black pixels inside the object when the white pixel thereof is reached for the first time, fill in the black pixels with corresponding original pixels of the image in a corresponding row thereof only when another white pixel of the object is found.

17. The AR system of claim 15, wherein the data processing device is further configured to least one of:
update the virtual box in accordance with the change in the at least one of xH, xL and y of the object in the subsequent run of the scanning of the image, and
when the object is not found within the updated virtual box in another subsequent run of the scanning of the image, scan for the object once again across an entirety of the image.

18. The AR system of claim 15, wherein the data processing device is further configured to:
eliminate undesired horizontal lines in the scanned image based on checking whether there is a white pixel at least one row above and one row below a black pixel, and
change the black pixel also into a white pixel when there is the white pixel at least one row above and one row below the black pixel.

19. The AR system of claim 15, wherein the data processing device is further configured to execute instructions to at least one of:
supplement the edge detection with color-based detection of pixels of the image through the scanning algorithm, and
compute at least one of: gradient vectors for the pixels within the image and image derivatives to further process the pixels of the image and enhance the edge detection of the object therein.

20. The AR system of claim 15, wherein the data processing device is further configured to:
identify moving parts of the object using a machine learning algorithm implemented in the data processing device interfaced with the scanning algorithm.
